(19) United States
(12) Patent Application Publication
(10) Pub. No.: US 2011/0241303 A1
(43) Pub. Date: Oct. 6, 2011

(54) Walkers with improved handles

(76) Inventor: Ronald B. Campbell, Saco, ME (US)

(21) Appl. No.: 13/158,385

(22) Filed: Jun. 11, 2011

Related U.S. Application Data
(63) Continuation-in-part of application No. 12/774,682, filed on May 5, 2010.
(60) Provisional application No. 61/176,250, filed on May 7, 2009.
(60) Provisional application No. 61/354,072, filed on Jun. 11, 2010.

(51) Int. Cl. A61H 3/04; A61H 3/00

(52) U.S. Cl. 280/87.041; 135/67

(57) ABSTRACT

Walkers whose handgrips permit users to maintain a generally upright posture while walking with the walker. The handgrips are oriented vertically instead of horizontally and are positioned on the walker such that when the walker and the user are standing on a surface, the user's forearm is angled slightly downward and the vertical grip has an angle which is substantially the same as the angle of the user's hand as determined by the downward angle of the user's forearm.

### CROSS-REFERENCE TO RELATED APPLICATIONS

The present patent application claims priority from U.S. provisional patent application 61/354,072, Ronald B. Campbell, Walkers with improved handles, filed Jun. 11, 2010. The present patent application is further a continuation-in-part of U.S. Ser. No. 12/774,682, Ronald B. Campbell, Walking stick with a handle that provides a user with improved grips, filed May 5, 2010. U.S. Ser. No. 12/774,682 further claims priority from U.S. provisional patent application 61/176,250, Ronald B. Campbell, Offset walking-stick head and foot therefor, filed May 7, 2009. The present patent application includes the entire Detailed Description of U.S. Ser. No. 12/774,682 and incorporates the entire contents of U.S. provisional patent application 61/176,250, of U.S. Ser. No. 12/774,682, and U.S. provisional patent application 61/354,072 by reference into the present patent application for all permissible purposes.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

1. Field of the Invention

The invention relates to walkers for assisting human beings in walking and more particularly to the locations of the handles on the walkers and the angles of their grips.

2. Description of Related Art

FIG. 4 shows a prior-art commercially available walker, the Medline Rolling Walker, sold by Medline Industries, Inc., Mundelein, Ill. 60060 USA. The portions of FIG. 4 which are particularly interesting in the present context are adjustable handlebars B and handgrips A. As shown in FIG. 4, in the Medline Rolling Walker, handgrips A are oriented substantially parallel to the ground. A handlebar B and a handgrip A form a single unit; attached to the handlebar is brake M, which has a handle which, when squeezed towards the handgrip, brakes the wheels so that they slow down, and when pushed away from the handgrip, locks the wheels. Sections 5 and 6 of the Assembly Instructions of FIG. 5 make it clear how a handlebar is attached to the walker's frame: it is inserted into the diagonal tube which connects to the front wheel G. The portion of the handlebar which is inserted into the diagonal tube has pairs of opposed holes and the height of the handle is adjusted by passing triangular hand screw L through the pair of the holes which puts the handle at the desired height. The handlebar is secured in the diagonal tube by tightening triangular handscrew L. Section 6 of the Assembly Instructions describes how to adjust the standard handles to the proper height. A problem with the Medline Rolling Walker and the many similar walkers is that because the handgrips are parallel to the ground, the user of the walker cannot maintain an upright posture. Why this is the case is discussed in detail in U.S. Ser. No. 12/774,682. Relevant portions of that discussion are included in the present application.

There is a class of walkers which has vertical handgrips. An example walker of this class is disclosed in U.S. patent application publication 2005/0156395, Bohn, Rolling walker with armrest platforms, published Jul. 21, 2005. The vertical handles of the walkers of this class do not serve to improve the posture of the users of the walkers. Instead, as pointed out at [003] and [004] of 2005/0156395, the vertical handgrips are made necessary by the fact that the walker is equipped with arm rests which provide additional support for users who are not strong enough to fully support their own weight. When the user is supported by the armrest, the user's hands are not in a position which permits the user to employ the standard horizontal handgrips, and the inventor has consequently provided vertical handgrips, as shown at 28 in FIG. 2. Because of the need for the user of Bohn's walker to be “inside” the walker when being supported by the armrests, the vertical handgrips are located on the opposite side of the walker from the horizontal handgrips.

### The Walking Sticks of the Parent of the Present Application

As indicated above, the present patent application is a continuation-in-part of U.S. Ser. No. 12/774,682, Ronald B. Campbell, Walking stick with a handle that provides a user with improved grips, filed May 5, 2010. The following discussion of walking sticks is from U.S. Ser. No. 12/774,682:

### Introduction to Walking Sticks

Humans have used walking sticks or canes (termed generically “walking sticks” in the following) since prehistoric times as aids in keeping their balance or providing support for the body's weight. In either application, the walking stick is often used to compensate for weakness in a leg: with the walking stick, the strength of the upper body becomes available to compensate for the leg's weakness.

All walking sticks include at least a shaft; many of them further provide a handle for the shaft. Walking sticks fall into two broad classes: long walking sticks, which the user grasps by curling his hand around the shaft of the walking stick, so that the palm of the hand encloses the shaft of the walking stick, and short walking sticks, which have a knob or handle on top of the shaft and which the user grasps by placing the palm of his hand on the handle or knob. Here the palm of the hand is at right angles to the shaft. In the following, a portion of a walking stick which is meant to serve as a place where the user grasps the walking stick is termed a grip; as may be seen by the foregoing, there are two broad classes of grips: vertical grips, which have the same general orientation as the axis of the walking stick's shaft and are grasped like the shaft of a long walking stick, and horizontal grips, which are oriented perpendicularly to the shaft and are grasped like the handle or knob of a short walking stick. The horizontal grip permits the user to place most of the weight of his or her body over the walking stick and press down on the stick; it is consequently particularly useful for activities like climbing stairs or getting out of chairs.

The long walking sticks are generally used where the primary problem is balance; in hiking or when someone is carrying a heavy load on his or her back. The length of the stick has two advantages:
the point at which the long walking stick's tip strikes the ground will generally be a good distance from the user's feet, thus making it easier for the user to keep his or her balance.
the user can walk with a generally upright posture.
   A disadvantage of the long walking stick is that only its vertical grip is useful; if the long walking stick has a knob or handle on its end, the horizontal grip provided by the knob or handle is too high to be useful in activities like stair climbing.

The short walking sticks are generally used where the primary problem is support for a weak leg. That is why they are short and have a horizontal grip. They are more useful than the long walking sticks for stair climbing and the like, but because the short walking stick is short, the user cannot walk with an upright posture while using the walking stick for support. Moreover, the short walking stick's tip strikes the ground relatively close to the user, making it not as good for keeping one's balance. The problems which the short walking stick poses with regard to the user's posture and balance are particularly significant when one considers that the users of the short walking sticks often have issues regarding balance and/or posture. For example, in many cases, a major goal of rehabilitation is that the patient to regain and maintain good posture; use of a short walking stick by the patient works against this goal. Another major goal of rehabilitation is overcoming the patient's fear of falling so that he or she can begin to walk again; the deficiencies of the short walking stick as regards balance walk against this goal as well.

It is an object of the invention of U.S. Ser. No. 12/774,682 to solve these and other problems of long and short walking sticks by providing a walking stick which combines the advantages of the long and short walking sticks and has the disadvantages of neither.

The object of the invention is attained in one aspect by a walking stick that has a shaft and a handle for its user's hand. The handle is joined to the shaft and provides the user's hand with a vertical grip on the walking stick which is oriented substantially vertically to the axis of the shaft but is offset from the axis.

In another aspect, the vertical grip has an angle with regard to the axis of the shaft. The shaft of the walking stick may have a length such that the user's forearm is angled slightly down when the walking stick is vertical, the user is standing on a plane, the end of the shaft is on the same plane, and the user's hand is holding the walking stick by the vertical grip. The vertical grip's angle is adapted to the angle of the user's hand which results when the user's forearm is so angled.

### BRIEF SUMMARY OF THE INVENTION

The parent of the present patent application, U.S. Ser. No. 12/774,682, Ronald B. Campbell, Walking stick with a handle that provides a user with improved grips, discloses a walking stick which has a handle with a vertical grip which is offset from the axis of the walking stick's shaft. The walking stick has a length such that when the user grasps the vertical grip, the user's forearm is angled at approximately 10-15° below horizontal. The vertical grip is angled towards the axis of the shaft to accommodate the angle of the hand when the forearm has the above angle. The advantages of the vertical grip's angle are explained in detail in U.S. Ser. No. 12/774,682. Mr. Campbell has since discovered that handles for walkers, wheeled or otherwise, which have similar angles relative to the vertical and are similarly located relative to the ground provide users of the walkers with substantially the same advantages as regards posture, respiration, and muscle use as those provided by the walking stick.

It is thus an object of the invention of the present patent application to provide an improved walker which permits a person who is walking with the aid of the walker to walk with a generally upright posture

The object is attained in one aspect by providing the walker with a handle that has a vertical grip and is located on the walker such that when the user walks with the walker while grasping the vertical grip, the user walks with a generally upright posture. The walker will generally have two of the handles. The walker may further be completely or partially wheeled or have no wheels.

In another aspect, the handle is further located on the free standing structure such that when the user is standing with the generally upright posture on a surface and the free standing portable structure is on the surface, the vertical grip is in a position to be grasped by the user's hand when the user's forearm is angled slightly downward and the vertical grip has an angle which is substantially the same as the angle of the user's hand as determined by the downward angle of the forearm. The forearm may be angled downward approximately 20° and the handle's location may be adjustable. The vertical grips may also be cushioned.

In a still further aspect, the invention is a kit for converting a walker with at least one original handle that is replaceable and adjustable and has a horizontal grip into a walker that permits the walker's user to have a generally upright posture while walking with the converted walker. The kit includes a replacement handle for the original handle. The replacement handle is adjustable and has a vertical grip. The replacement handle is further adjustable such that when the replacement handle has replaced the original handle on the walker and the user is standing with the generally upright posture on a surface and the free standing portable structure is on the surface, the vertical grip is in a position to be gasped by the user's hand when the user's forearm is angled slightly downward and the vertical grip has an angle which is substantially the same as the angle of the user's hand as determined by the downward angle of the forearm.

Other objects and advantages will be apparent to those skilled in the arts to which the invention pertains upon perusal of the following Detailed Description and drawing, wherein:

### BRIEF DESCRIPTION OF THE SEVERAL VIEWS OF THE DRAWINGS

FIG. 1 shows an embodiment of a walking stick with a vertical grip that is offset from the walking stick's shaft and two horizontal grips;

FIG. 2 shows three ways in which a user may grip the walking stick of FIG. 1; and

FIG. 3 shows a walking stick of FIG. 1 which is has a forked tip, with each branch of the fork ending in a separate elastomeric tip.

FIG. 4: view of a standard Medline Rolling Walker;

FIG. 5: assembly instructions provided by Medline for the Rolling Walker;

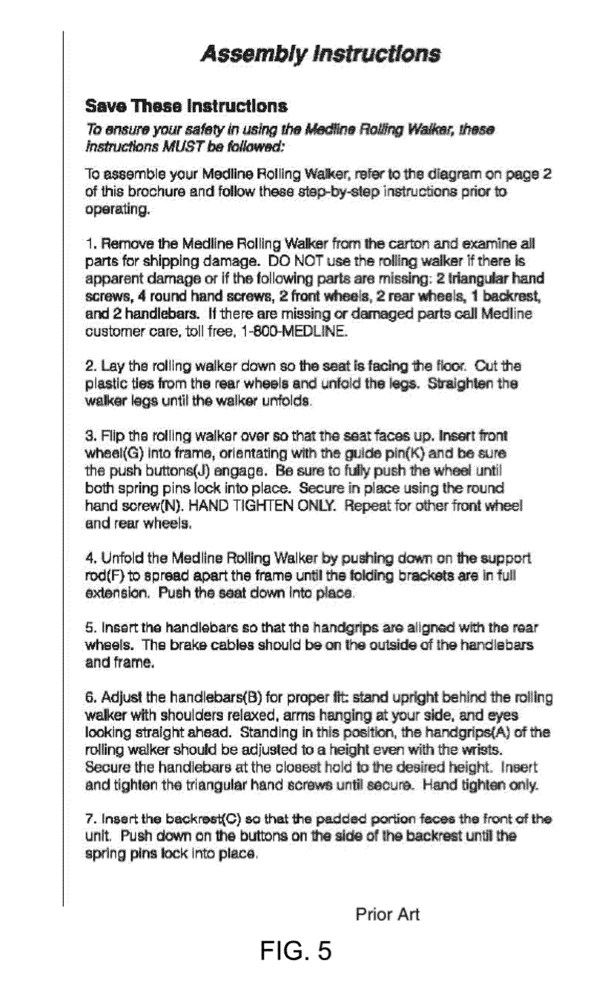

FIG. 6: a Medline Rolling Walker which has been converted into a walker with improved handles;

FIG. 7: A converted Medline Rolling Walker in use; and

FIG. 8: Further improvements in the handles

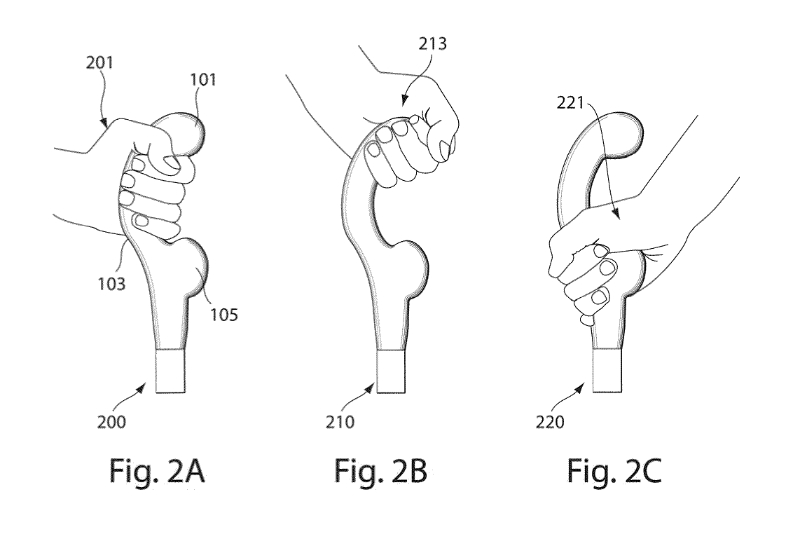

Reference numbers in the drawing have three or more digits: the two right-hand digits are reference numbers in the drawing indicated by the remaining digits. Thus, an item with the reference number 203 first appears as item 203 in FIG. 2.

### DETAILED DESCRIPTION OF THE INVENTION

The following disclosure of walker handles which have substantially the same characteristics as regards angle from the vertical and height relative to the ground as the walking stick handles of U.S. Ser. No. 12/774,682 includes the complete Detailed Description and Drawing of U.S. Ser. No. 12/774,682.

Walking Stick with a Handle that Provides a User with Improved Grips

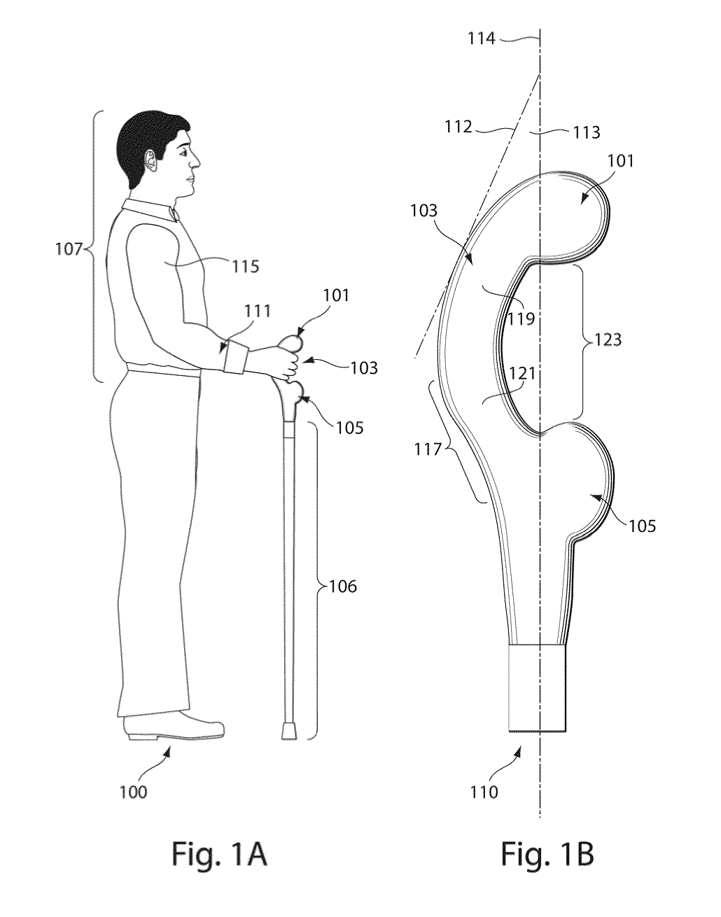

### Overview of a Preferred Embodiment of the Walking Stick: FIG. 1

FIG. 1A shows a user 100 holding an embodiment of the walking stick. As can be seen from FIG. 1A, the walking stick is longer than the standard short walking stick, but is not as long as the standard long walking stick. The embodiment is made up of handle 103 and shaft 106. Shaft 106 is long enough that when the user is holding the cane by the vertical grip provided by handle 103, the user is upright as shown at 107, and his arm 115 is slightly bent below the horizontal as shown at 111. At this angle, downward force on the walking stick comes from the user's triceps muscles, rather than from the user's biceps, as is the case with long walking sticks that have vertical grips at positions which require a more acute angle between the lower and upper arm.

The vertical grip provided by handle 103 is offset from the axis of shaft 106 at its bottom and is angled towards the axis of the shaft at its top. The angle is chosen to fit the angle of the hand when lower arm 111 is at the angle shown and the hand is gripping the vertical grip. The offset of the handle from the shaft keeps the user's hand from simply sliding down the shaft when the user presses down on the walking stick. The angle of the vertical grip not only increases the comfort of the user but also brings the user's hand closer to the axis 114 of shaft 106. Other features of interest are knob 101 and knob 105, which may be used as horizontal grips. Knob 105 is particularly useful when wing up stairs and knob 101 is particularly useful when coming down stairs. FIGS. 2 A, B, and C show the three modes of gripping the walking stick: at 200 is shown gripping the walking stick using the offset vertical grip provided by handle 103; at 210 is shown gripping it using the upper horizontal grip provided by knob 101; at 220 is shown gripping it using the lower horizontal grip provided by knob 105.

### DETAILS OF A PREFERRED EMBODIMENT

FIG. 1B provides details of a preferred embodiment of handle 103. Knobs 101 and 105 are located so that when they are employed as horizontal grips, the palm of the hand is over the axis 114 of the walking stick's shaft. As shown at 117, the vertical grip 119 is offset by portion 121 from the axis 114 of the shaft. Grip 119 angles back towards the axis 114 of the walking stick's staff. The angle 113 is chosen to fit the angle of the hand which results from the arm's angle 111, which is 10-15° from the horizontal. The opening between the knobs 101 and 105 is 3 to 4½ inches, depending on the size of the user's hand.

### Variations

While embodiments of the invention in which the handle has the configuration shown in FIG. 1B are particularly advantageous, many variations are possible. To give some examples:
The handle may only have offset grip 119, without knobs 101 and 105;
The handle may have either knob 105 or knob 101, but not both;
the walking stick may extend above handle 103;
offset grip 119 of the handle may extend further towards axis 114, putting the hand closer to the axis of the shaft when the walking stick is being held using the vertical grip;
The handle has the form of a loop, with offset 121 and vertical grip 119 being one side of the loop.

In some embodiments, the offset vertical grip may not be angled back towards the axis of the shaft. In others, the offset vertical grip may be higher on the walking stick and may have the angle required for that position. In still others, there may not be a vertical grip, but solely a structure that serves to separate two horizontal grips in a short walking stick that is particularly adapted to stair climbing. The walking stick shafts and handles may be of course made of any material which has the necessary strength, from wood through synthetic materials to metals. In some embodiments, the shaft may be telescoping, to permit easier adaptation of the walking stick to individuals having different builds. In others, there may be differently-sized handles for differently-sized hands, and a walking stick may be personalized by selecting a handle and a shaft that fit the individual for whom the walking stick is intended and combining them to make the walking stick. The selected handle can also be combined with a telescoping shaft that has been set to the proper length.

### A Forked Foot for the Walking Stick

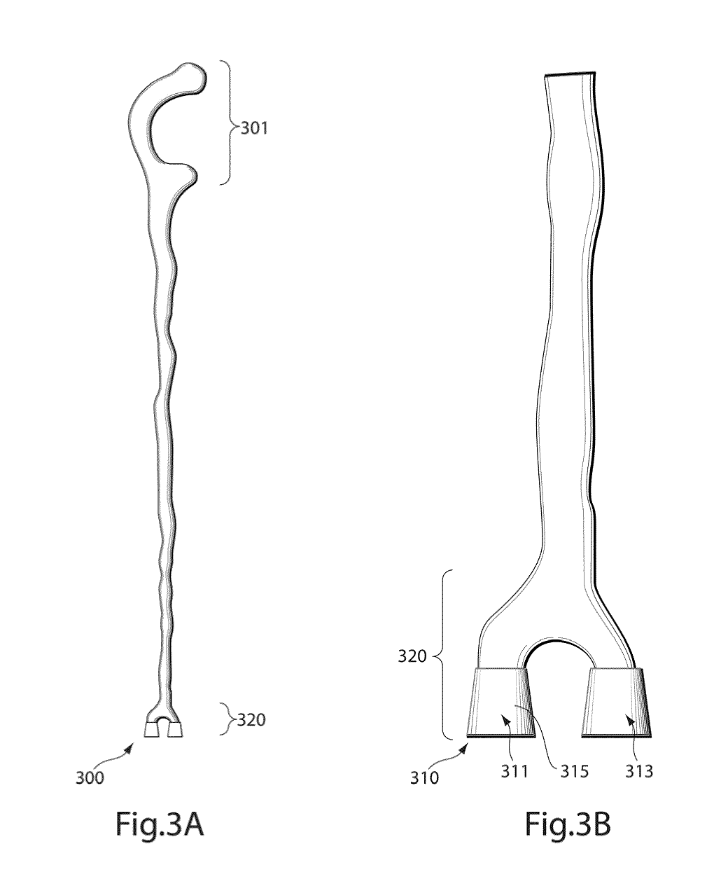

The length of the walking stick and the vertical grip permit the walking stick to have a longer “stride” than a short walking stick. That in turn results in an increased angle from the vertical when the walking stick first makes contact with the ground in a stride or breaks contact with the ground at the end of the stride, and the increased angle increases the probability that the tip of the shaft will slip at the beginning or end of the stride. This problem can be dealt with by means of the forked foot 310 shown in FIGS. 3A and 3B, which reduces the angle from the vertical. The fork 320 is in the same plane as the handle and has a skid resistant tip 315 on the end of each branch 311 and 312. In a preferred embodiment, there is 1″ between the branches.

When the user is using a horizontal grip and consequently pressing directly down on the shaft, the two skid-resistant tips are simultaneously in contact with the surface the downward pressure is being directed against and consequently increase the skid resistance of the walking stick in that situation as well. This effect is strengthened in the stair-climbing situation when the horizontal grips are arranged in a fashion such that when the user grasps the horizontal grip, the palm of the user's hand is not only horizontal to the axis of the shaft but at right angles to the plane of the handle. Because the fork is in the plane of the handle, the user can place the fork at the point where the step's tread and riser meet and the fork will be parallel to the riser. Other embodiments may have other arrangements to prevent the tip of the shaft from skidding; for example, in some cases, more than two feet may be useful.

Walkers with Improved Handles

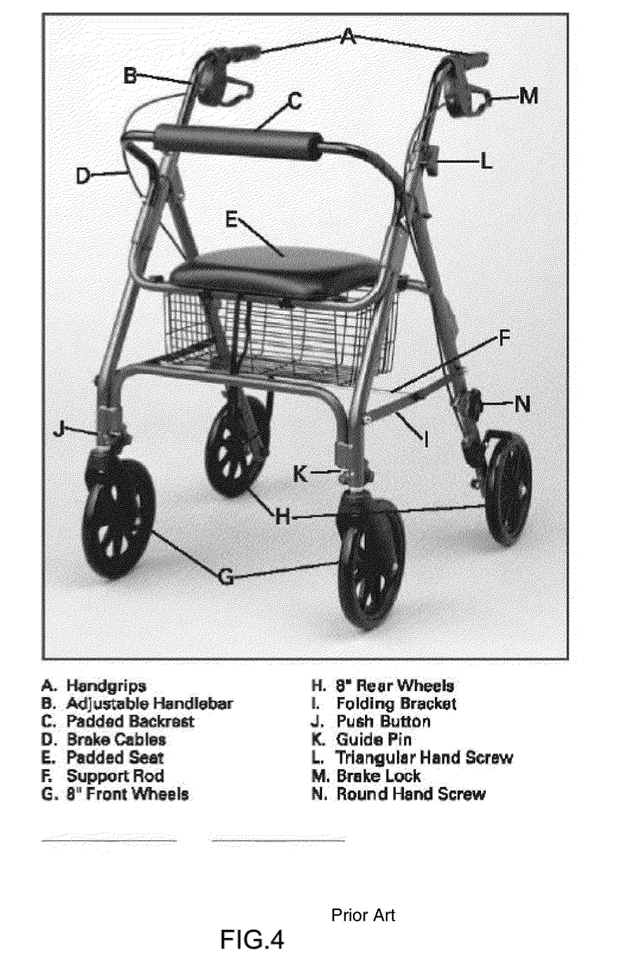

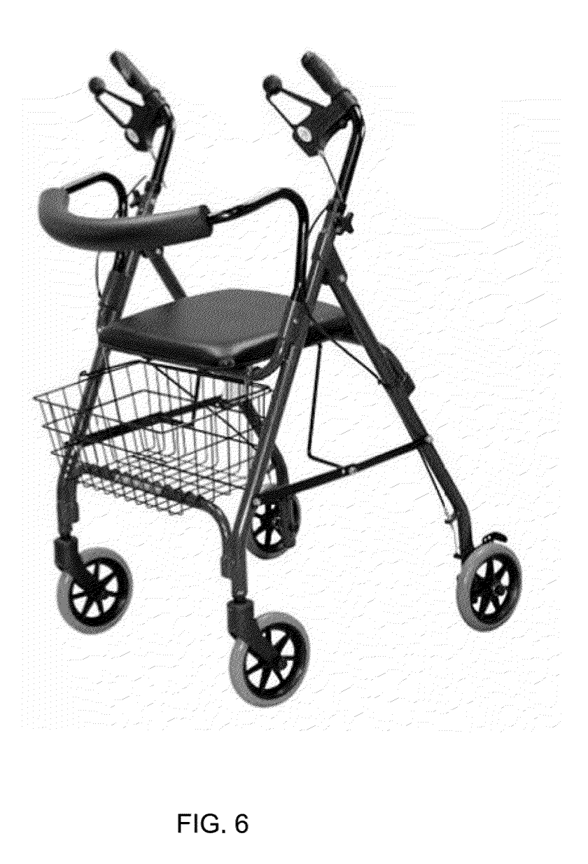

FIG. 6 shows a Medline Rolling Walker like that shown in FIG. 4 which has been converted into a walker in which the handgrips have angles from the vertical substantially similar to those of the cane handles of U.S. Ser. No. 12/774,682. The conversion is done simply by placing the handlebars in the tubes, rotating them 180° from the position they have when the handgrips are oriented parallel to the ground, and securing them with hand screw L as described above. The height of the handles after conversion is determined as follows: Stand upright behind the rolling walker, with shoulders relaxed, arms bent forward to about 20 degrees below horizontal, and eyes looking straight ahead. Standing in this position, the handlebars should be adjusted to a height such that the handgrips of the rolling walker fit comfortably with the wrists. Use the hand screws to set the height and secure the handlebars as described above.

The simple conversion described above has two shortcomings:
When the holes of the original handlebars are used in the conversion, the converted handles were not in parallel vertical planes.
The grips of the original handlebars where intended to take a considerable portion of the user's weight and were consequently made of a hard material.

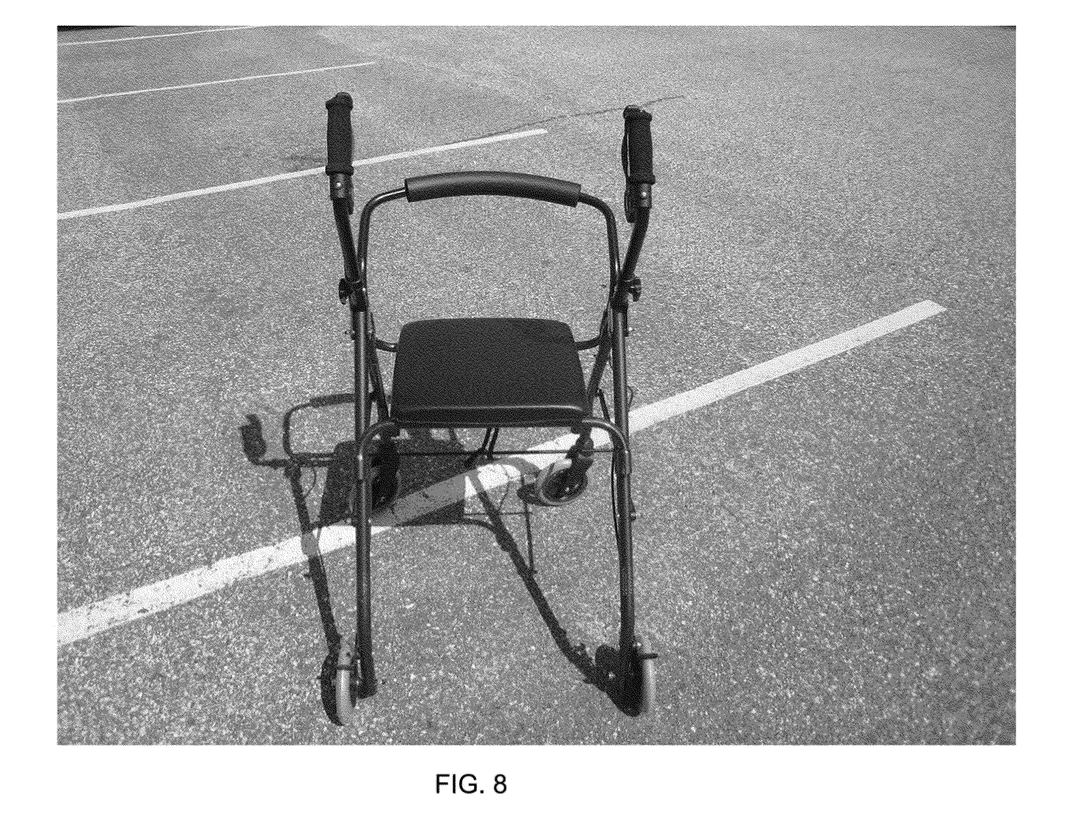

FIG. 8 shows a conversion which remedies these shortcomings: the handles are now in parallel vertical planes and have soft grips. To overcome the shortcomings, the handles were rotated so that they were in parallel vertical planes and the holes for the pins were re-drilled. The hard material of the original grips was replaced with softer shock absorbing material.

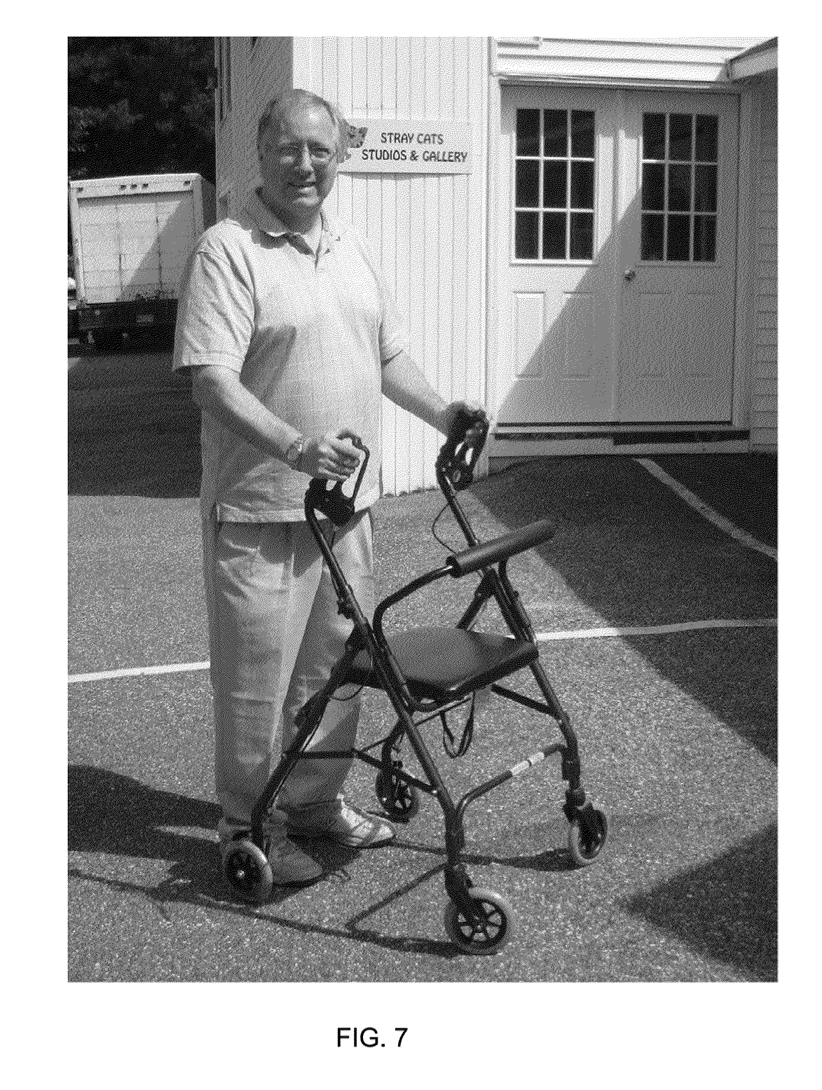

FIG. 7 shows the converted Medline Rolling Walker in use. The desired angle of the lower arms is clearly shown in FIG. 7. It should be noted here that the angle of the handgrips from the vertical in the converted walker is a serendipitous result of the manner in which the handlebars are attached to the Medline Rolling Walker's frame. In other embodiments, other angles from the vertical may be equally or better adapted to providing the user of the walker with advantages similar to those provided to users of the cane handles of U.S. Ser. No. 12/774,682. It should also be noted that handgrips having angles similar to the angles of the handles for the converted rolling walker may be employed with walkers that are not rolling or that have wheels only on their front legs.

### Conversion Kits for Walkers

A great many walkers with horizontal handgrips have been manufactured. In many such walkers, the horizontal handgrips are easily removable. One example of a walker in which the horizontal handgrips are removable is the Medline rolling walker of FIG. 4. Walkers with easily removable horizontal handgrips can be converted to walkers with vertical handgrips by means of conversion kits. A conversion kit would typically contain a replacement vertical handgrip for each of the removable horizontal handgrips. Where the removable horizontal handgrip had adjustment mechanisms, the replacement vertical handgrip could work with those adjustment mechanisms, as is the case with the replacement vertical handgrips shown in FIG. 8. If there were no such adjustment mechanisms for the horizontal handgrips or if those adjustment mechanisms were not suited for the vertical handgrips, adjustment mechanisms for the replacement vertical handgrips could be included in the kit. Similarly, if the horizontal handgrips included brake handles, the brake handles could be reused with the vertical replacement handgrips or new brake handles could be provided.

### CONCLUSION

The foregoing Detailed Description has disclosed how walkers may be equipped with vertical handgrips so that a user who is grasping the vertical grips as he or she is walking with the roller is able to walk with a generally upright posture. The Detailed Description has further disclosed how a commercially available rolling walker may be made into a walker with vertical handgrips and how the vertical handgrips may be further improved. As will be immediately apparent to those skilled in the relevant technologies, the exact form of the vertical handgrips, the manner in which they are attached to the walker, and the form of the walker will depend on the intended user of the walker and the environment in which the walker is to be used. The vertical handgrips will be in general adjustable, and any kind of adjustment mechanism may be employed which suits the user and the environment. For all of the foregoing reasons, the Detailed Description is to be regarded as being in all respects exemplary and not restrictive, and the breadth of the invention disclosed herein is to be determined not from the Detailed Description, but rather from the claims as interpreted with the full breadth permitted by the patent laws.

1. A walker for assisting a person in walking, the walker comprising:
a free-standing portable structure and
a handle with a vertical grip, the handle being located on the free-standing portable structure such that when the user walks with the walker while grasping the vertical grip, the user walks with a generally upright posture.

2. The walker set forth in claim 1 wherein:
the free-standing portable structure includes a plurality of wheels; and
the free-standing portable structure rolls on the wheels when the user walks with the walker.

3. The walker set forth in claim 2 wherein:
the handle includes a brake for a wheel of the wheels.

4. The walker set forth in claim 1 wherein:
there are two of the handles, one for each hand of the user, the user grasping both handles while walking with the walker.

5. The walker set forth in claim 4 wherein:
the free-standing portable structure has a plurality of contact points with the ground; and
the two handles and the two contact points of the plurality which are closest to the user when the user walks with the walker while grasping the vertical grips define a substantially vertical plane.

6. The walker set forth in claim 5 wherein:
the two handles and the two contact points further substantially define a rectangle in the vertical plane.

7. The walker set forth in claim 5 wherein:
there are one or more additional contact points that are less close to the user.

8. The walker set forth in claim 7 wherein:
at least some of the contact points are wheels; and
the free-standing portable structure rolls on the wheels when the user walks with the walker.

9. The walker set forth in claim 8 wherein:
there are two additional contact points: and
the additional contact points are wheels and the two contact points are not wheels.

10. The walker set forth in claim 7 wherein:
the contact points and the additional contact points are wheels; and the free-standing portable structure rolls on the wheels when the user walks with the walker.

11. The walker set forth in claim 10 wherein:
at least one of the handles includes a brake for a wheel of the wheels.

12. The walker set forth in claim 1 wherein:
the handle is further located on the free standing portable structure such that when the user is standing with the generally upright posture on a surface and the free standing portable structure is on the surface, the vertical grip is in a position to be grasped by the user's hand when the user's forearm is angled slightly downward and the vertical grip has an angle which is substantially the same as the angle of the user's hand as determined by the downward angle of the forearm.

13. The walker set forth in claim 12 wherein:
the user's forearm is angled downward approximately 20°.

14. The walker set forth in claim 12 wherein:
the handle's location on the free standing portable structure in adjustable so that the vertical grip is in a position to be grasped by the user's hand when the user's forearm is angled slightly downward and the vertical grip has an angle which is substantially the same as the angle of the user's hand as determined by the downward angle of the forearm.

15. The walker set forth in claim 12 wherein:
the vertical grips are cushioned.

16. A walker comprising:
a rolling free-standing portable structure; and
a pair of handles, each handle having a vertical grip, the handles being located on the rolling free-standing portable structure such that when the user walks on a surface using the rolling free standing portable structure, the user is standing in a generally upright posture on the surface and the user's hands are grasping the vertical grips, the user's forearm is angled slightly downward and the vertical grip has an angle which is substantially the same as the angle of the user's hand as determined by the downward angle of the forearm.

17. A kit for converting a walker with at least one original handle that is replaceable and adjustable and has a horizontal grip into a walker that permits the walker's user to have a generally upright posture while walking with the converted walker,
the kit comprising:
for the original handle, a replacement handle that is adjustable and has a vertical grip, the replacement handle being adjustable such that when the replacement handle has replaced the original handle on the walker and the user is standing with the generally upright posture on a surface and the free standing portable structure is on the surface, the vertical grip is in a position to be grasped by the user's hand when the user's forearm is angled slightly downward and the vertical grip has an angle which is substantially the same as the angle of the user's hand as determined by the downward angle of the forearm.
